(19) United States
(12) Patent Application Publication
(10) Pub. No.: US 2025/0367688 A1
(43) Pub. Date: Dec. 4, 2025

(54) FLUID SPRAYER AND AIR CAP FOR A FLUID SPRAYER

(71) Applicant: Graco Minnesota Inc., Minneapolis, MN (US)

(72) Inventor: Christopher C. Wagner, Saint Anthony, MN (US)

(21) Appl. No.: 19/196,144

(22) Filed: May 1, 2025

Related U.S. Application Data
(60) Provisional application No. 63/654,465, filed on May 31, 2024.

(51) Int. Cl. B05B 7/08

(52) U.S. Cl. CPC B05B 7/0815

(57) ABSTRACT

A spray gun includes a spray tip that has a nozzle that is configured to output spray fluid. An air cap is configured to directed flows of compressed gas onto the fluid output to shape and/or atomize the spray fluid. The air cap is configured to output larger volume flows towards faces of the spray output. Adjusting the larger volume flow changes the pattern size of the spray fluid.

### CROSS-REFERENCE TO RELATED APPLICATION

This application claims the benefit of U.S. Provisional Application No. 63/654,465 filed May 31, 2024 and entitled “FLUID SPRAYER AND AIR CAP FOR A FLUID SPRAYER,” the disclosure of which is hereby incorporated by reference in its entirety.

### BACKGROUND

This disclosure relates to sprayers. More specifically, this disclosure relates to air caps for sprayers.

Spray guns can be used to spray fluids on surfaces. For example, spray guns can be used to spray paint, lacquer, finishes, dielectric material, and other coatings on furniture, cabinets, appliances, equipment, fabricated components, etc.

Typically, the spray fluid is placed under pressure by a piston, diaphragm, or other positive displacement pump. The pump can place the spray fluid under pressure between 500 to 5,000 pounds per square inch (psi), although higher and lower pressures are possible. The pump outputs the spray fluid under pressure through a flexible hose. A spray gun is used to dispense the spray fluid, the gun being attached to the end of the hose opposite the pump. In this way, the spray gun does not include a pump, but rather releases spray fluid pumped to the spray gun through the hose. The spray gun atomizes the spray fluid under pressure into a spray fan, which is applied to a surface.

Some spray guns, which can be referred to as air-assisted airless spray guns, emit airflows to assist in atomizing and/or shaping the fluid spray. Such spray guns emit fluid through a spray nozzle and emit the airflows proximate the fluid spray. Such spray guns include valves to control the fluid flow and the one or more airflows.

### SUMMARY

According to one aspect of the present disclosure, an air cap for a spray gun includes a cap body having a central aperture therethrough, the central aperture disposed on a body axis of the cap body; a plurality of projections extending from an outer side of the cap body; and a first set of passages extending through the cap body, the first set of passages extending to a plurality of ports open on the outer side. The plurality of ports include a first subset of ports disposed circumferentially between a first projection of the plurality of projections and a second projection of the plurality of projections, the first subset of ports oriented to direct a first plurality of airflows towards the body axis and towards a first face of the spray pattern; and a second subset of ports disposed circumferentially between the first projection and the second projection, the second subset of ports opposing the first subset of ports such that the second subset of parts are oriented to directed a second plurality of airflows towards the body axis and towards a second face of the spray pattern.

According to an additional or alternative aspect of the present disclosure, a spray cap assembly for use with a spray gun includes a spray tip and an air cap. The spray tip includes a tip body having a spray orifice formed therethrough; and a tip notch formed in the tip body, the tip notch extending laterally such that a spray pattern emitted from the spray tip is laterally elongate, wherein the spray orifice opens into the tip notch. The air cap includes a cap body supporting the spray tip, the cap body having a central aperture therethrough, the central aperture disposed on a body axis of the cap body; a plurality of projections extending from an outer side of the cap body; and a first set of passages extending through the cap body, the first set of passages extending to a plurality of ports open on the outer side. The plurality of ports include a first subset of ports disposed circumferentially between a first projection of the plurality of projections and a second projection of the plurality of projections; and a second subset of ports disposed circumferentially between the first projection and the second projection. The first subset of ports oriented to direct a first plurality of airflows towards the body axis and towards a first broad face of the spray pattern. The second subset of ports opposing the first subset of ports such that the second subset of parts are oriented to directed a second plurality of airflows towards the body axis and towards a second broad face of the spray pattern.

According to another additional or alternative aspect of the present disclosure, a method of spraying a coating liquid includes outputting the coating liquid through a spray tip, the spray tip atomizing the coating liquid into a liquid spray shaped to have a width between a first pattern side and a second pattern side and a thickness between a first pattern face and a second pattern face, the width greater than the thickness; outputting compressed gas through an air cap and towards the spray pattern such that a first portion of the compressed gas is output through a first plurality of ports and towards the first pattern face and a second portion of the compressed gas is output through a second plurality of ports and towards the second pattern face; and adjusting flow of the first portion of the compressed gas and the second portion of the compressed gas to change the width of the spray pattern, wherein increasing the flow of the first portion of the compressed gas and the second portion of the compressed gas increases the width and decreasing the flow of the first portion of the compressed gas and the second portion of the compressed gas decreases the width.

### BRIEF DESCRIPTION OF THE DRAWINGS

FIG. 1A is a rear isometric view of a spray gun.

FIG. 1B is a front isometric view of the spray gun.

FIG. 1C is a side elevational view of the spray gun.

FIG. 2 is an enlarged cross-sectional view of a flow control portion of the spray gun.

FIG. 3A is an enlarged, partial isometric view of a spray gun showing emission of coating liquid and compressed gas.

FIG. 3B is a cross-sectional view taken along line B-B in FIG. 3A.

FIG. 4A is a front elevational view of an air cap.

FIG. 4B is a first isometric view of the air cap.

FIG. 4C is a second isometric view of the air cap.

FIG. 4D is a cross-sectional view taken along line D-D in FIG. 4A.

FIG. 4E is a cross-sectional view taken along line E-E in FIG. 4A.

FIG. 4F is a cross-sectional view taken along line F-F in FIG. 4A.

FIG. 5 is a top view of a cap assembly showing emission of spray fluid.

FIG. 6A is a cross-sectional view of a spray tip.

FIG. 6B is a side elevational view of a spray tip.

FIG. 7 shows a first spray pattern applied on a surface.

FIG. 8 shows a second spray pattern applied on a surface.

### DETAILED DESCRIPTION

This disclosure relates to fluid spraying. More specifically, this disclosure relates to air-assisted airless spraying. An air-assisted airless (AA) spray gun is configured to emit a spray of spray fluid, such as paints, varnishes, lacquers, fine finishes, high-gloss finishes, waterborne coatings, solvent-borne coatings, dielectric material, etc. The air-assisted airless spray gun can be used to apply coatings to surfaces, furniture, cabinets, appliances, equipment, fabricated components, electronics, etc., The air-assisted airless spray gun also emits compressed air. An assist air portion of the compressed air is configured to assist in blending of fan tails to prevent tailing ad provide for a smooth even finish. A fan air portion of the compressed air is configured to assist in atomization of the spray fluid and shape the spray pattern. The spray fluid is emitted through a spray tip and the air is emitted through an air cap. The spray gun is configured to spray at fluid pressures up to about 34.5 megapascal (MPa) (about 5,000 pounds per square inch (psi)). In some examples, the spray gun is configured to spray at fluid pressures up to about 10 MPa (about 1,500 psi). In some examples, the spray gun is configured to spray at air pressures up to about 0.7 MPa (about 100 psi).

According to aspects of the disclosure, an air cap and spray tip are configured to form a tip assembly. The spray tip is mounted relative to the air cap to properly orient the spray pattern output by the sprayer. Orienting the spray tip aligns the spray pattern with the compressed air emitted from the air cap. Such alignment provides desired effects of the compressed gas on the emitted spray fluid.

A spray tip can be configured to at least partially atomize the spray fluid. The spray tip can be configured to output the spray fluid in a spray pattern. For example, the spray tip can include a shaped output, such as in a cat-eye configuration, that assists in shaping the liquid spray emitted from the spray tip. The spray tip is disposed such that a spray plane along which the emitted pattern is widened and narrowed divides fan air ports of the air cap into subsets. The spray plane extends through prongs of the air cap.

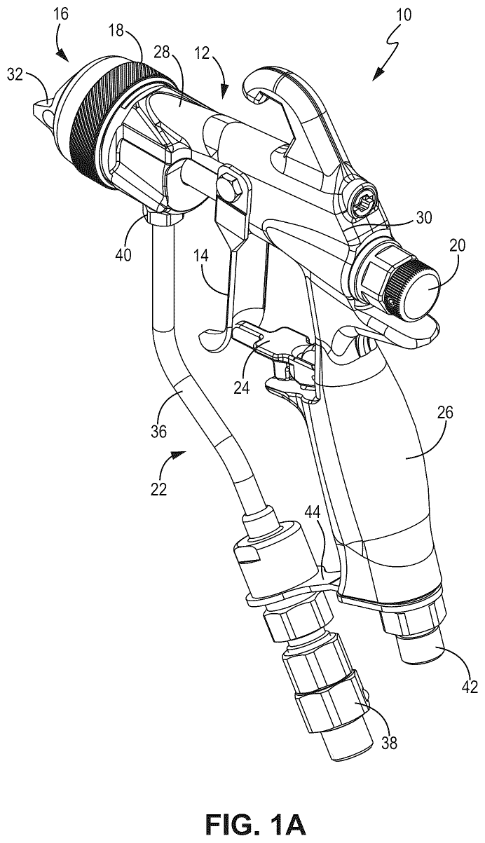

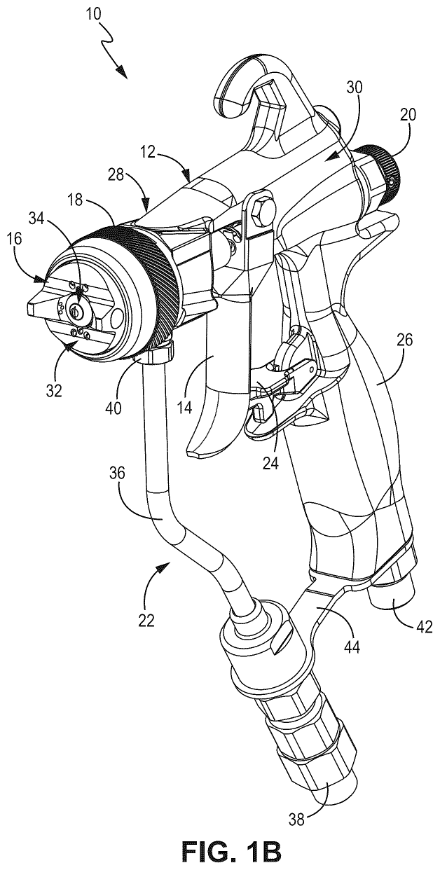

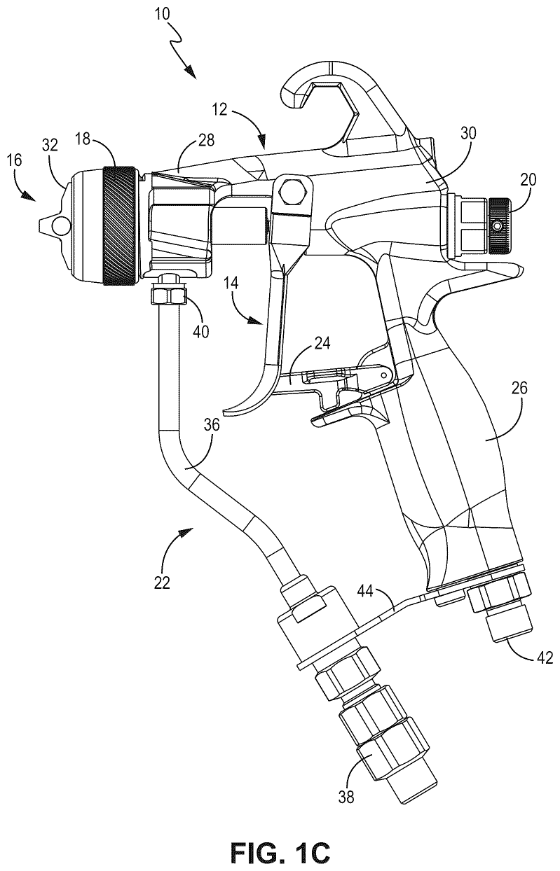

FIG. 1A is a rear isometric view of spray gun 10. FIG. 1B is a front isometric view of spray gun 10. FIG. 1C is side elevation view of spray gun 10. FIGS. 1A-1C will be discussed together. Gun body 12, trigger 14, cap assembly 16, collar 18, knob 20, fluid tube assembly 22, and trigger lock 24 are shown. Gun body 12 includes handle 26, front end 28, and rear end 30. Cap assembly 16 includes air cap 32 and spray tip 34. Fluid tube assembly 22 includes fluid tube 36, lower fluid fitting 38, upper fluid fitting 40, air fitting 42, and connector 44.

Spray gun 10 is configured to receive spray fluid and compressed gas and to emit fluid sprays. Gun body 12 supports various components of spray gun 10. Cap assembly 16 is configured to emit the fluid spray. The air cap 32 is configured to emit compressed gas. Spray tip 34 is configured to emit liquid sprays. Spray tip 34 can be at least partially disposed within air cap 32. In some examples, spray tip 34 extends through air cap 32 to emit spray fluid. Spray tip 34 can include a shaping orifice, such as in a cat-eye configuration, configured to shape the liquid spray emitted from spray tip 34. Spray tip 34 is configured to at least partially atomize the liquid emitted through spray tip 34.

Collar 18 secures cap assembly 16 to gun body 12. Trigger 14 is mounted to gun body 12 and configured to actuate both air and fluid valves, as discussed in more detail below. Trigger lock 24 is movable between a deployed state and a stowed state. In the deployed state, trigger lock 24 interfaces with trigger 14 to prevent actuation of trigger 14. In the stowed state, trigger lock 24 is spaced from trigger 14 such that trigger 14 can be actuated. In the example shown, trigger lock 24 is configured to be oriented horizontally in the deployed state and oriented vertically in the stowed state. Knob 20 extends from rear end 30 of gun body 12 and is disposed above handle 26. Knob 20 can interface with an air valve within gun body to adjust an opening through that air valve, as discussed in more detail below.

Fluid tube assembly 22 is attached to gun body 12. Lower fluid fitting 38 is configured to connect to a hose to receive spray fluid. Fluid tube 36 extends between lower fluid fitting 38 and upper fluid fitting 40. Fluid tube 36 conveys spray fluid to upper fluid fitting 40. Upper fluid fitting 40 is connected to a block within gun body 12 that provides the spray fluid to a fluid valve in gun body 12. Air fitting 42 is connected to handle 26 and provides compressed air to air flowpaths through gun body 12. Connector 44 extends between and maintains a desired spacing between lower fluid fitting 38 and air fitting 42. Connector 44 can be a strip of material, such as plastic or metal, that maintains the spacing and connection.

During operation, the user can grasp handle 26 of gun body 12 with a single hand and can manipulate spray gun 10 with the single hand. The user can manipulate trigger 14 with the single hand and actuate trigger 14 to initiate spraying by spray gun. Actuating trigger 14 causes air and fluid valves to open such that spray gun 10 emits both spray fluid and air. Releasing trigger 14 allows the valves to return to the normally closed states, stopping the flow of both spray fluid and air.

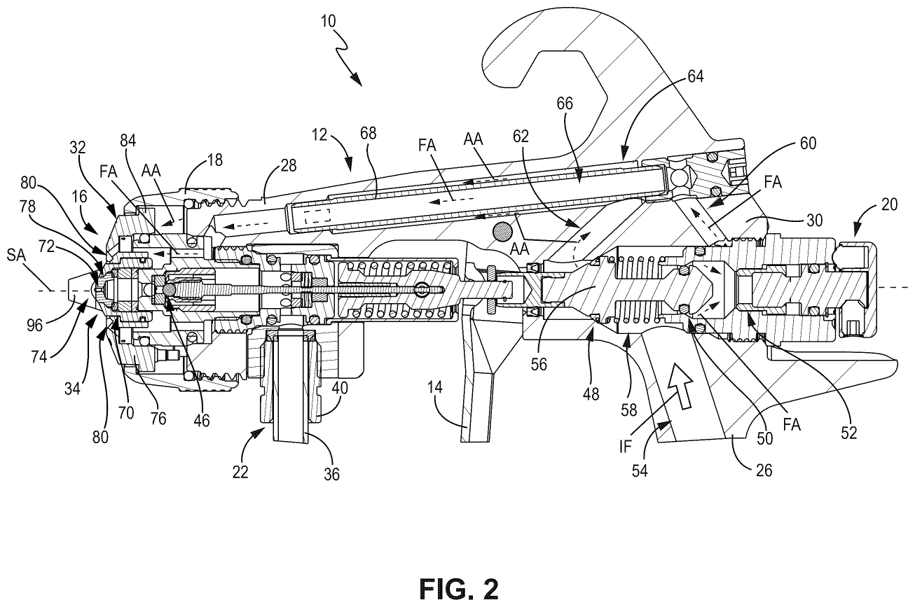

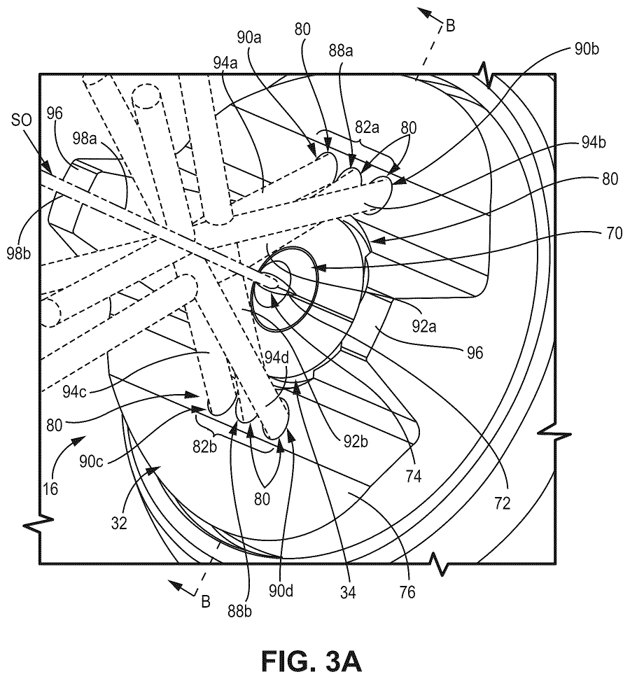

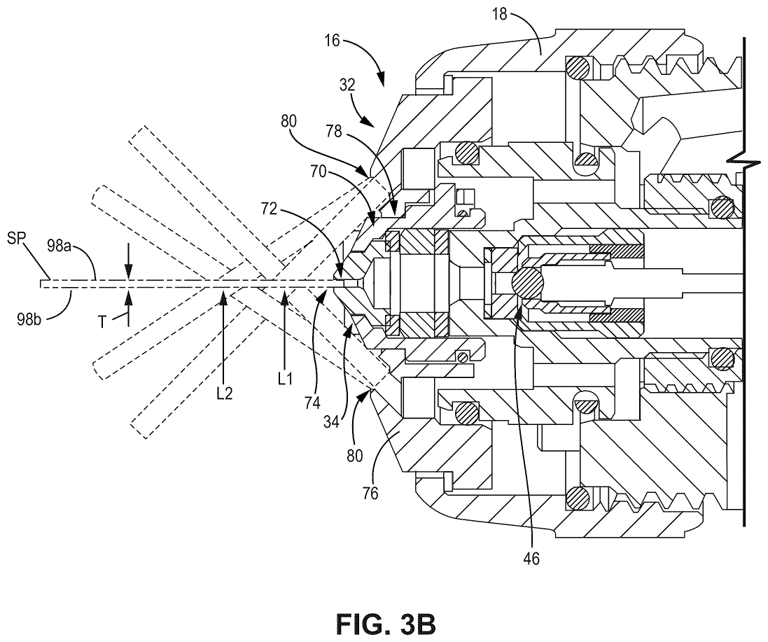

FIG. 2 is a partial cross-sectional view of spray gun 10 showing flow control and spraying components of spray gun 10. FIG. 3A is an enlarged partial isometric view of spray gun 10 showing emission of coating liquid and compressed gas. FIG. 3B is a cross-sectional view taken along line B-B in FIG. 3A. Gun body 12, trigger 14, cap assembly 16, collar 18, knob 20, handle 26, fluid valve 46, assist air valve 48, fan air valve 50, and fan control valve 52 of spray gun 10 are shown. Spray gun 10 can operate as disclosed in International Application No. PCT/US2021/037433 assigned to Graco Minnesota, Inc., the disclosure of which is hereby incorporated by reference in its entirety.

Gun body 12 supports other components of spray gun 10. Spray gun 10 receives flows of spray fluid, such as liquids, such as paint, among other options, and receives flows of compressed gas. Fluid valve 46 controls spray fluid flow to spray tip 18.

The compressed air can be received through air inlet bore 54 in handle 26. Assist air valve 48 controls flow of an atomizing portion of the compressed gas to air cap 32. Fan air valve 50 controls flow of a fan air portion of the compressed gas to air cap 32. In the example shown, the fan air valve 50 and the assist air valve 48 are connected for simultaneous actuation. The movable valve member 56 forms the movable component of both the fan air valve 50 and the assist air valve 48. It is understood, however, that not all examples are so limited.

Fan control valve 52 is configured to control flow of the fan air portion of the compressed gas to air cap 32. Fan control valve 52 is formed separately from fan air valve 50. Fan control valve 52 can be set independently of the fan air valve 50. Fan control valve 52 can be adjusted further open to increase flow of the fan air portion to air cap 32 and can be adjusted further closed to decrease flow of the fan air portion to air cap 32. In the example shown, the assist air valve 48 and the fan air valve 50 are controlled by trigger 14 while the fan control valve 52 can be independently set and is unaffected by trigger pull.

It is understood, however, that fan control valve 52 may not be included in all examples. For example, in an automatic spray gun the compressed gas is fed through one or more feed lines to the automatic spray gun. Some examples of such a spray gun can include three feed lines, a first for supplying the fan air, a second for supplying the assist air, and a third for supplying compressed gas to actuate the trigger and cause spraying. In such an automatic sprayer, the flow of the compressed gas can be controlled remotely, such as from a control station, to adjust flow of the fan air and/or assist air to the air cap 32.

The assist air can flow downstream to air cap 32 with the assist air valve 48 in the open state. The flow of the assist air is unaffected by the opening state of the fan control valve 52. The fan air can flow downstream to air cap 32 with the fan air valve 50 in the open state. The fan air can continue downstream to the air cap 32 with the fan control valve 52 in the open state. In the example shown, the fan air portion thereby requires multiple valves to be simultaneously open while the assist air portion requires a single valve to be open.

While the fan air portion FA and assist air portion AA are shown as flowing through first and second flowpaths, respectively, it is understood that the fan air portion FA can be directed to the second flowpath and the assist air portion AA can be directed to the first flowpath in other embodiments of spray gun 10, depending on the internal pathway configurations for routing the air downstream of the assist air valve 48 and fan air valve 50. The inlet air flow (IF) flows through inlet bore 54 in handle 26 and to air valve bore 58. Inlet bore 54 extends through handle 26 to air valve bore 58. Fan air bore 60 and assist air bore 62 extend from air valve bore 58.

Flow passage 64 and flow passage 66 route compressed gas to the air cap 32. The flow passage 64 and flow passage 66 are configured to provide flows of compressed gas to air cap 32. The flow passage 64 and the flow passage 66 are configured to provide separate flows of compressed gas to air cap 32. In the example shown, the flow passage 64 routes the assist air portion and the flow passage 66 routes the fan air portion.

The flow passage 64 and flow passage 66 are fluidly isolated from each other to separately provide the fan air portion and the assist air portion. Such a configuration allows for discrete control of the separate compressed gas portions, providing control for shaping and configuring the spray pattern. In the example shown, the flow passage 64 and the flow passage 66 are fluidly separated by air tube 68 such that gas flowing within one of the passages does not mix with gas flowing within the other passage and does not cross over between the passages.

Trigger 14 is mounted to gun body 12. Trigger 14 is configured to control actuation of various valves to control flow of the coating liquid to spray tip 34 and the flow of compressed gas to air cap 32. Trigger 14 is spaced from handle 26. In the example shown, spray gun 10 is configured as a manual spray gun in which a user grasps the handle 26 and actuates the trigger 14 with a hand of the user. It is understood, however, that in various other examples the spray gun 10 can be configured as an automatic spray gun (e.g., pneumatically actuated, electrically actuated, etc.) to control actuation of the valves.

Cap assembly 16 is mounted to gun body 12. Cap assembly 16 is configured to atomize the spray fluid into a spray pattern. Spray tip 34 is disposed at least partially within air cap 32. Air cap 32 and spray tip 34 form the cap assembly 16 that is configured to atomize the coating liquid and shape the spray pattern output by spray gun 10.

Spray tip 34 is disposed downstream of fluid valve 46 to receive the spray fluid from fluid valve 46. Spray tip 34 includers a tip body 70. Spray orifice 72 is formed through tip body 70. Spray orifice 72 is aligned on the spray axis SA along which the coating liquid is output from spray gun 10. Tip notch 74 is formed in the tip body 70. Tip notch 74 is laterally elongate. The spray orifice 72 opens into tip notch 74 such that the coating liquid is emitted through spray orifice 72 and through tip notch 74. In the example shown, tip notch 74 is formed as a cut in the outer surface of tip body 70. In the example shown, tip notch 74 is formed as a V-shaped cut, though it is understood that other configurations are possible. In the example shown, tip body 70 includes a domed outer surface and the tip notch 74 extends into the domed outer surface of the tip body 70.

Air cap 32 is mounted so gun body 12. In the example shown, air cap 32 is mounted to gun body 12 by collar 18, through it is understood that other configurations are possible. The air cap 32 includes cap body 76. Cap body 76 defines central aperture 78 that is disposed on the spray axis SA. The spray tip 34 can be at least partially disposed within the central aperture 78. Prongs 96 project outward. In the example shown, the prongs 96 bracket the spray output from spray tip 34 such that a width W of the spray output SO extends laterally between the prongs 96.

Air cap 32 is configured to output both the fan air portion of the compressed gas and the assist air portion of the compressed gas. The air cap 32 outputs the fan air portion through fan ports 80. The fan ports 80 are disposed on opposite sides of the spray output SO such that port subset 82a is oriented to direct fan air towards face 100a of spray output SO and port subset 82b is oriented to direct fan air towards the opposite face 100b of spray output SO. Port subset 82a is disposed on an opposite side of the spray plane SP along which the spray pattern can be widened and narrowed from port subset 82b. In the example shown, all fan ports 80 of port subset 82a are disposed on an opposite side of the spray plane SP from all fan ports 80 of port subset 82b.

Collar 18 interfaces with air cap 32 and an end of gun body 12. Collar 18 retains air cap 32 in position relative other portions of spray gun 10 and connects air cap 32 to gun body 12. Collar 18 can secure air cap 32 such that spray tip 34 is braced by air cap 32. In the example shown, collar 18 includes a threaded interface, though other connection types are possible. Collar 18 can hold air cap 32 on spray gun 10. In the example shown, collar 18 overlaps with cap flange 84 to interface with air cap 32 and clamp air cap 32 to spray gun 10.

Knob 20 is disposed outside of gun body 12 and is accessible by the user. In the example shown, knob 20 is connected to fan control valve 52 such that an opening distance of the fan control valve 52 can be adjusted by grasping and manipulating knob 20. For example, knob 20 can be rotated to cause the fan control valve 52 to open further or close further.

During spray operations, spray fluid and compressed air are provided to spray gun 10. The spray fluid is provided through the fluid tubing. Fluid valve 46 is in a closed state and prevents the coating liquid from flowing to spray tip 34. The compressed gas is provided through air inlet bore 54 through handle 26. The compressed gas enters the air chamber in air valve bore 58. The assist air valve 48 and fan air valve 50 are initially closed and prevent compressed gas from flowing to air cap 32. Fan control valve 52 can be placed in a desired opening position to configure the spray pattern.

The user grasps handle 26 and pulls trigger 14 towards handle 26 to initiate spraying. Trigger 14 moves and cause the assist air valve 48 and fan air valve 50 to shift to respective open states. In some examples, spray gun 10 is configured such that compressed gas begins to flow to cap assembly 16 prior to the fluid valve 46 opening and the coating liquid flowing to spray tip 34. The assist air valve 48 and fan air valve 50 can be configured to simultaneously shift to their respective open states.

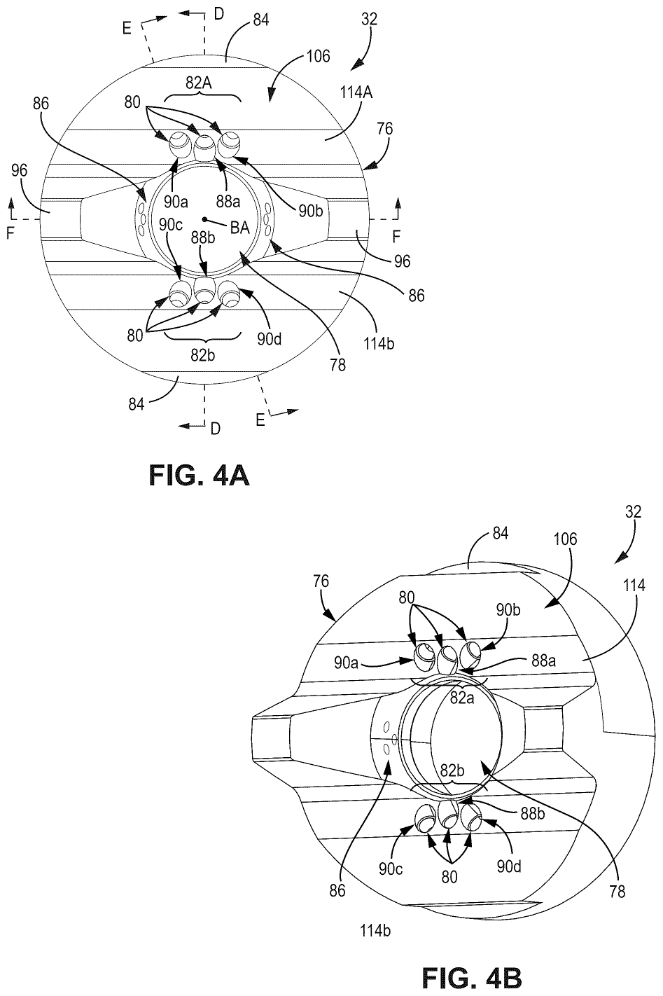

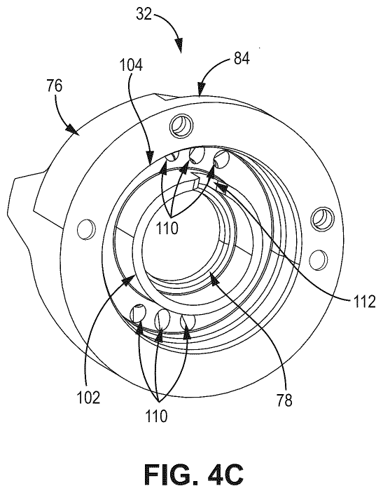

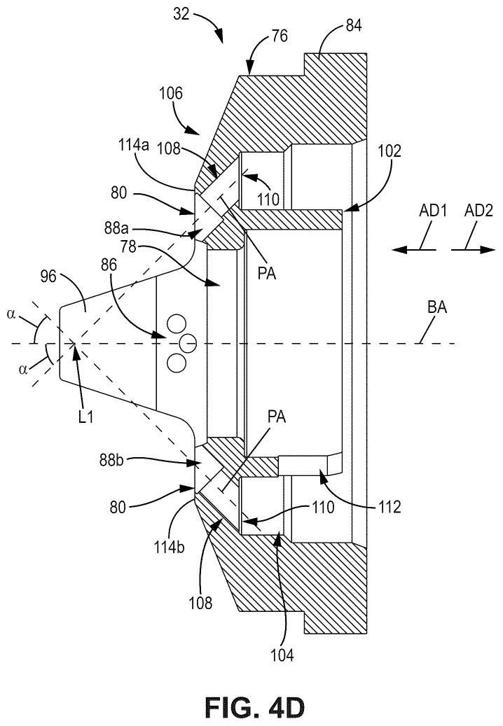

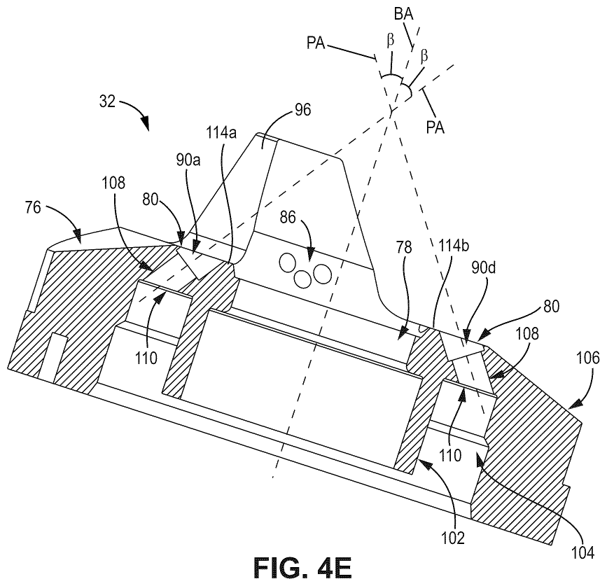

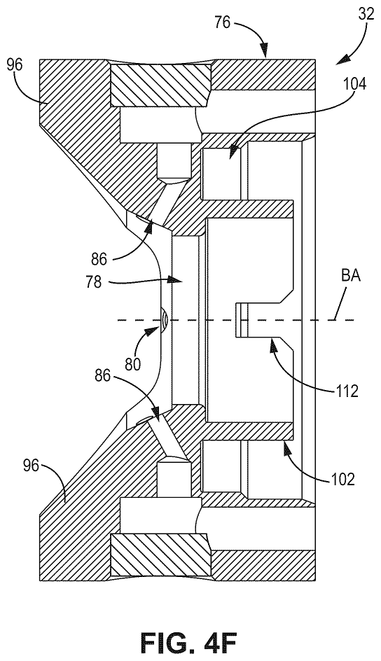

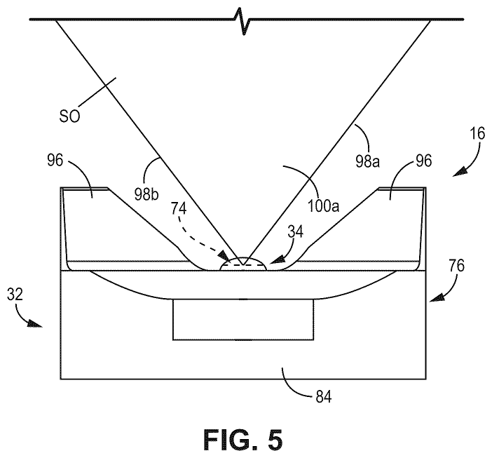

An assist air portion of the compressed air flows through assist air valve 48 and to air cap 32. The assist air is emitted through air cap 32. The assist air portion is emitted from edge ports 86 (best seen in FIGS. 4A, 4B, and 4F) of air cap 32. Edge ports 86 can be formed through prongs 96. The assist air portion is directed towards pattern edges 98a, 98b (FIG. 5) of the spray output SO. The assist air portion is directed towards the thickness T of the spray output SO. The assist air portion is directed towards the pattern edges 98a, 98b and can assist in blending of tails in the spray pattern. The assist air portion further protects the air cap 32 by blowing the coating liquid away from prongs 96, thereby helping keep the air cap 32 clean.

A fan air portion of the compressed air flows through fan air valve 50. In the example shown, flow of the fan air portion to air cap 32 is controlled by fan control valve 52. If fan control valve 52 is in a closed state, then the fan air portion is prevented from flowing to air cap 32 and no fan air is emitted from spray gun 10. If fan control valve 52 is in an open state, then the fan air portion flows by fan control valve 52 and is emitted through air cap 32. The fan control valve 52 can be adjusted to various positions between fully open and fully closed to control the flow of the fan air portion to the air cap 32. The opening position of the fan control valve 52 controls the flow of the fan air portion, which can vary the spray pattern. In the example shown, increasing flow of the fan air portion increases the width W of the spray pattern while decreasing flow of the fan air portion increases width W of the spray pattern. The fan air portion can assist in atomization of the coating liquid as well as shaping the spray pattern.

The fan air portion is emitted from fan ports 80 of air cap 32. The fan air portion is directed towards pattern faces 100a, 100b of the spray output SO. The fan air portion is directed towards the width W of the spray output SO. As best seen in FIGS. 3A and 3B, port subset 82a directs a first set of airflows towards pattern face 100a and the port subset 82b directs a second set of airflows towards pattern face 100b.

Each port subset 82a, 82b includes the same number of fan ports 80 in the example shown. Port subset 82a includes central port 88a and side ports 90a, 90b. Port subset 82b includes central port 88b and side ports 90c, 90d. The port subsets 82a, 82b are opposed from each other and configured to direct the fan air towards the faces 100a, 100b of the spray pattern. The spray plane SP extends between the port subsets 82a, 82b such that port subsets 82a, 82b are disposed on opposite sides of the spray plane SP.

In the example shown, the fan ports 80 are configured to direct the fan air towards different locations of the spray pattern. Central ports 88a, 88b are opposed from each other. The central ports 88a, 88b are oriented such that the outputs from the central ports 88a, 88b intersect at location L1 along the spray axis SA. Location L1 is spaced axially outward from spray tip 34 along the spray axis SA. The location L1 forms a focal point for the outputs from the central ports 88a, 88b.

The central ports 88a, 88b direct their respective outputs axially outward along the spray axis SA and radially inwards towards the spray axis SA. In the example shown, the central ports 88a, 88b do not direct their respective outputs laterally. Instead, the central ports 88a, 88b direct their respective outputs straight towards the spray axis SA. In the example shown, central ports 88a, 88b are disposed such that a plane orthogonal to the spray plane SP and extending along spray axis SA extends through both central ports 88a, 88b. Such a plane can bisect the central ports 88a, 88b. The outputs from the central ports 88a, 88b can be directed along that plane and towards the spray axis SA. The outputs can remain planar with that orthogonal plane as directed towards the spray axis SA. In the example shown, central port 88a emits central flow 92a and central port 88b emits central flow 92b. Central flow 92a and central flow 92b are both directed towards location L1.

In the example shown, side ports 90a, 90b are opposed to each other. Side port 90a is configured to emit side flow 94a. Side port 90b is configured to emit side flow 94b. The multiple side ports 90a, 90b of port subset 82a direct their respective outputs laterally inwards towards the spray axis SA. The multiple side ports 90a, 90b of port subset 82a are configured to direct flows towards a common location L2 along the spray axis SA.

In the example shown, side ports 90c, 90d are opposed to each other. Side port 90c is configured to emit side flow 94c. Side port 90d is configured to emit side flow 94d. The multiple side ports 90c, 90d of port subset 82b direct their respective outputs laterally inwards towards the spray axis SA. The multiple side ports 90c, 90d of port subset 82b are configured to direct flows towards a common location L2 along the spray axis SA.

In the example shown, the side ports 90a, 90b of port subset 82a and the side ports 90c, 90d of port subset 82b oppose each other. The side ports 90a, 90b of port subset 82a and side ports 90c, 90d of port subset 82b each direct their output towards a common focal point at location L2. In the example shown, side ports 90a, 90c are disposed on a same lateral side of central ports 88a, 88b. Side ports 90b, 90d are disposed on a same lateral side of central ports 88a, 88b and are disposed on an opposite lateral side of central ports 88a, 88b from side ports 90a, 90c. Side ports 90a, 90c are oriented to direct their outflows in a same lateral direction towards spray axis SA. Side ports 90b, 90d are oriented to direct their outflows in a same lateral direction towards the spray axis SA. The side ports 90a, 90c direct their outflows in an opposite lateral direction from side ports 90b, 90d.

In the example shown, the air cap 32 is configured to direct the fan air portion towards multiple focal points disposed along the spray axis SA. In the example shown, the focal point for central ports 88a, 88b is at location L1 and the focal point for the side ports 90a-90d is at location L2. Location L1 is disposed axially closer to spray tip 34 than location L2. In the example shown, a greater number of outputs meet at the focal point axially further from spray tip 34 than at the focal point axially closer to spray tip 34. In the example shown, the outputs that meet axially further from spray tip 34 are directed laterally while the outputs that meet axially closer to spray tip 34 are not directed laterally.

The multiple focal points for the fan air outputs from the air cap 32 facilitates effective and efficient shaping and atomization of the spray output SO. The laterally oriented outputs are directed further axially from spray tip 34 than the central ports 88a, 88b. Such a configuration facilitates the outputs from central ports 88a, 88b, which are not laterally directed, onto the spray output for pattern formation and atomization. The multiple side ports 90a-90d are focused further from the spray tip 34 than the central ports 88a, 88b. The outputs from the multiple side ports 90a-90d can further atomize and shape the spray output SO from the spray tip 34.

The user releases trigger 14 to stop spraying. Fluid valve 46 is closed, such as by a spring, and the flow of spray fluid downstream through spray tip 34 is stopped. The assist air valve 48 and fan air valve 50 are returned to respective closed states, such as by one or more springs. Assist air valve 48 being closed stops the flow of assist air downstream to air cap 32. Fan air valve 50 being closed stops the flow of fan air downstream to air cap 32. In the example shown, the fan control valve 52 can remain in an open state, thereby preserving the size of the restriction through the fan control valve 52 and thus the desired flow for atomization and shaping of the spray pattern for the next trigger pull. In some examples, the fluid valve 46 is configured to close prior to the assist air valve 48 and fan air valve 50 closing. As such, spray gun 10 can be configured to stop emitting spray fluid before spray gun 10 stops emitting compressed gas.

In some examples, both the fluid valve 46 and the air flow valves (assist air valve 48 and fan air valve 50) are spring actuated. The spring that closes fluid valve 46 can have a higher spring rate than the spring that closes the air valves, such that the emission of coating liquid is stopped before the emission of compressed gas. The continued emission of compressed gas after emission of the coating liquid stops prevents undesired material buildup and clogging.

Spray gun 10 provides significant advantages. Cap assembly 16 facilitates efficient atomization and shaping of the coating liquid output by spray gun 10. Spray tip 34 is configured to atomize the coating liquid output through spray tip 34. The spray tip 34 further shapes the coating liquid output to a base pattern having a width W and a thickness T. The spray pattern is elongate widthwise along a spray plane SP. The air cap 32 is configured to output flows of compressed gas towards the faces 100a, 100b of the spray pattern. The fan ports 80 output multiple discrete flows towards the opposite faces 100a, 100b of the spray pattern. The spray plane SP is disposed between the port subsets 82a, 82b and the multiple fan ports 80 are configured to direct their outputs towards the faces of the spray plane SP. The outputs from each of the fan ports 80 is oriented transverse to, and not along and within, the spray plane SP.

The fan ports 80 are oriented towards different focal points along the spray axis SA. The multiple focal points are spaced along the spray axis SA. The fan ports 80 oriented towards each of the multiple focal points are oriented to direct their outputs transverse to the spray plane SP. Such a configuration facilitates efficient atomization by impinging on the coating liquid and multiple locations along the spray axis SA and transverse to the spray plane SP. Such a transverse configuration relative to the spray plane SP also facilitates intuitive pattern control such that increasing gas flow through fan ports 80 increases the width W while decreasing gas flow through fan ports 80 decreases the width W.

FIG. 4A is a front elevational view of air cap 32. FIG. 4B is an isometric view of air cap 32. FIG. 4C is a rear isometric view of air cap 32. FIG. 4D is a cross-sectional view taken along line A-A in FIG. 4A. FIG. 4E is a cross-sectional view taken along line E-E in FIG. 4A. FIG. 4F is a cross-sectional view taken along line F-F in FIG. 4A. FIG. 5 is a top elevational view of cap assembly 16 showing a spray pattern emission relative to the air cap 32. FIGS. 4A-5 are discussed together.

Air cap 32 includes cap body 76, central aperture 78, fan ports 80, edge ports 86, tip mount 102, and flow groove 104. Cap body 76 is disposed about body axis BA. Body axis BA is configured to be coaxial with the spray axis SA with air cap 32 mounted to a spray gun 10. Central aperture 78 extends through cap body 76. Central aperture 78 extends fully axially through cap body 76 and is open in both axial directions along the body axis BA. Air cap 32 is configured to receive the spray tip 34 at least partially within central aperture 78 to form the cap assembly 16.

Prongs 96 extend axially outward in first axial direction AD1 from outer side 106 of cap body 76. Prongs 96 can be considered to form portions of the cap body 76. Prongs 96 can be formed monolithically with other portions of cap body 76, among other options. Prongs 96 are disposed on opposite lateral sides of the central aperture 78. The central aperture 78 can be considered to be bracketed by the prongs 96. The prongs 96 bracket the spray pattern output by the cap assembly 16. The prongs 96 laterally bracket the spray pattern such that the spray output extends widthwise between the prongs 96. The prongs 96 are disposed such that the spray plane SP passes through the prongs 96. In some examples, the spray plane SP can bisect each prong 96.

Fan ports 80 are formed through outer side 106 of cap body 76. Fan ports 80 are oriented to direct flows of compressed gas towards the faces 100a, 100b of the spray output SO from the spray tip 34. Fan ports 80 are disposed in port subset 82a and port subset 82b. Port subset 82a is disposed on an opposite circumferential side of each prong 96 from port subset 82b. The port subsets 82a, 82b are disposed radially outward of central aperture 78. The port subsets 82a, 82b are disposed on opposite sides of the spray plane SP from each other. All fan ports 80 of port subset 82a are disposed on one side of the spray plane SP and all fan ports 80 of port subset 82b are disposed on the opposite side of the spray plane SP.

In the example shown, each port subset 82a, 82b includes three fan ports 80. It is understood, however, that other numbers of fan ports 80 are possible within each port subset 82a, 82b. Port subset 82a includes central port 88a and side ports 90a, 90b. Port subset 82b includes central port 88b and side ports 90c, 90d. Each fan port 80 is oriented to direct its output towards a face 100a, 100b of the spray plane SP. Each fan port 80 is oriented to direct its output towards the body axis BA in the example shown. The fan ports 80 are configured to output discrete flows of the fan air. The fan ports 80 do not overlap but are instead separated from each other on outer surface 106.

Fan passages 108 are formed through the cap body 76 between the fan ports 80 and inlet ports 110. The inlet ports 110 are disposed on an opposite side of the cap body 76 from the fan ports 80. In the example shown, each fan passage 108 extends along a passage axis PA. The fan passages 108 are configured such that the passage axes PA of the central ports 88a, 88b intersect at a first focal point along the body axis BA. The fan passages 108 are configured such that the passage axes PA of the side ports 90a-90d intersect at a second focal point along the body axis BA. The second focal point is disposed further axially from the spray tip 34 than the first focal point. The focal points are spaced in axial direction AD1 from the spray tip 34, which axial direction AD1 is outward with regard to the direction of spray.

In some examples, each fan port 80 has the same diameter as the other fan ports 80. In some examples, fan ports 80 have a different diameter than portions of the fan passage 108. In some examples, the fan port 80 can have a larger diameter than the fan passage 108 that feeds that fan port 80. The diameter of the fan port 80 can be taken along a plane normal to the passage axis PA. The aperture of the fan port 80 that opens on outer side 106 is oblong. The larger diameter of the fan port 80 than the fan passage 108 can assist in dispersing the output from the fan port 80 and can assist in atomization and shaping of the pattern.

In the example shown, the fan ports 80 are formed through side portion 114a and side portion 114b of the cap body 76. In some examples, multiple, up to all, of the fan ports 80 are formed fully in a side portion 114a, 114b. Side portions 114a, 114b are disposed on opposite sides of the central aperture 78. Side portion 114a is disposed on an opposite circumferential side of both prongs 96 from side portion 114b. In the example shown, the side portions 114a, 114b are to facie axially relative to the body axis BA. The side portions 114a, 114b can, in some examples, be disposed in a common plane, the common plane disposed normal to the body axis BA. In some examples, the side portions 114a, 114b can be disposed in a common plane that is orthogonal to the spray plane SP.

The fan passages 108 of the central ports 88a, 88b are best seen in FIG. 4D. As shown, the fan passage 108 is sloped such that the inlet port 110 is disposed radially further from the body axis BA than the fan port 80. The fan passage 108 is sloped to direct the fan air radially inwards and towards the body axis BA. In the example shown, the central ports 88a, 88b are sloped at angle α to output flow towards the body axis BA. The central ports 88a, 88b are sloped at the same angle α to direct the outputs from both central ports 88a, 88b towards a common focal point.

The fan passages 108 of side ports 90a, 90d are best seen in FIG. 4E. As shown, the fan passage 108 is sloped such that the inlet port 110 is disposed radially further form the body axis BA than the fan port 80. The fan passages 108 are also canted laterally such that the inlet ports 110 that feed the side ports 90a-90d are disposed further laterally outward than the side ports 90a-90d. The fan passages 108 associated with the side ports 90a-90d are configured to direct the fan air radially inwards and towards the body axis BA. In the example shown, the fan passages 108 associated with the side ports 90a, 90d are sloped at angle β to output flow towards the body axis BA. The side ports 90a, 90d are sloped at the same angle β to output flow towards the body axis BA. The side ports 90a, 90d are sloped at the same angle β to direct the outputs from both side ports 90a, 90d towards a common focal point. It is understood that side ports 90b, 90c can be configured the same as side ports 90a, 90d.

In the example shown, angle β is shallower than angle α. For example, angle β can be about 35-degrees while angle α can be about 45-degrees, though it is understood that other configurations are possible. The shallower angle β directs the outputs of the side ports 90a-90d towards a focal point further axially outward from the spray tip 34 than the focal point for the outputs of the central ports 88a, 88b.

The inlet ports 110 of the are spaced further circumferentially apart than the fan ports 80 through the outer side 106. The side ports 90a, 90b are oriented such that the fan passages 108 of the side ports 90a, 90b converge towards the central port 88a between the inlet ports 110 and side ports 90a, 90b. Such a configuration directs the outputs of the side ports 90a, 90b laterally inwards towards the body axis BA. The fan passages 108 associated with the side ports 90c, 90d converge towards the central port 88b between the inlet ports 110 and side ports 90c, 90d. Such a configuration directs the outputs of the side ports 90c, 90d laterally inwards towards the body axis BA.

In the example shown, the fan ports 80 within each port subset 82a, 82b are radially offset relative to others of the fan ports 80 in the same port subset 82a, 82b. In the example shown, the central ports 88a, 88b are disposed radially closed to body axis BA than the side ports 90a-90d. The fan ports 80 can be considered to be disposed in a chevron configuration within each port subset 82. It is understood, however, that not all examples are so limited. For example, the multiple fan ports 80 within a port subset 82a, 82b can be linearly aligned with each other, the central ports 88a, 88b can be disposed radially outward of the side ports 90a-90d, among other options.

Edge ports 86 are best seen in FIG. 4F. Edge ports 86 are aligned with the prongs 96. In some examples, the edge ports 86 can be formed at least partially within the prongs 96. The edge ports 86 are fluidly isolated from the fan ports 80. The compressed gas that is fed to edge ports 86 does not mix with the compressed gas that is fed to fan ports 80 at locations within air cap 32. Such fluid isolation allows for discrete control of the assist air flowing through edge ports 86 and the fan air flowing through fan ports 80. The edge ports 86 are sloped to direct their outputs axially outward from spray tip 34. The edge ports 86 are oriented towards the edges 98a, 98b of the spray output SO and can be directed along the spray plane SP. The edge ports 86 are configured to direct flows laterally along and, in some examples, transverse to, spray plane SP. The outputs from edge ports 86 the multiple edge ports 86 can be directed towards the body axis BA. In some examples, each edge port 86 has the same diameter as the other edge ports 86.

In the example shown, the fan ports 80 are larger than the edge ports 86. Each fan port 80 can output a greater volume of compressed gas than each edge port 86. In some examples, the diameter of a fan port 80 can be at least twice as large as the diameter of an edge port 86. In some examples, the diameter of the fan passage 108 can be larger than the diameter of the edge port 86. In some examples, the diameter of the fan passage 108 can be at least 1.5 times the diameter of the edge port 86.

Tip mount 102 extends in second axial direction AD2, which is an inward direction along the body axis BA with regard to the spray output. Tip mount 102 extends at least partially around central aperture 78. Tip mount 102 is configured to receive the spray tip 34. Tip mount 102 can interface with the spray tip 34 to mount the spray tip 34 to the air cap 32. In the example shown, the tip mount 102 is monolithically formed with other portions of cap body 76. In the example shown, tip mount 102 is formed as a ring that extends in the second axial direction AD2. The tip mount 102 can be cylindrical, among other options.

Locator 112 is configured to interface with spray tip 34 to orient spray tip 34 relative to air cap 32. In the example shown, the locator 112 forms a rotation lock that is configured to prevent rotation of the spray tip 34 on the body axis BA. Rotationally fixing the spray tip 34 maintains the spray plane SP in a desired orientation relative to the fan ports 80 and edge ports 86 of the air cap 32. In the example shown, locator 112 is formed as a notch in the tip mount 102. The notch forming the locator 112 is configured to receive a projection extending from the spray tip 34 to rotationally lock the spray tip 34 relative to the air cap 32, as shown in FIG. 3B. In the example shown, the locator 112 is formed at a location that is circumferentially between the prongs 96 of the air cap 32. While locator 112 is shown as formed as a notch, it is understood that locator 112 can be of any suitable configuration for fixing the relative orientations of the air cap 32 and spray tip 34. For example, the tip mount 102 can include a contoured interior surface and the spray tip 34 can include a contoured exterior that mates with the contoured interior at a keyed interface, the locator 112 formed by the contoured interior. In other examples, the locator 112 can be formed as a projection that is received in a slot of the spray tip 34. In the example shown, the locator 112 is configured to provide unidirectional mounting for the spray tip 34. The spray tip 34 can be mounted in a single orientation such that the tip notch 74 and thus the spray plane SP extend laterally. It is understood that in various other examples the air cap 32 can be configured to rotationally fix spray tip 34 in a plurality of orientations. For example, the spray tip 34 can be mounted in two orientations that are 180-degrees apart from each other to orient spray tip 34 for generating the laterally elongated spray output.

Flow groove 104 is disposed in cap body 76. Flow groove 104 is at least partially defined by tip mount 102, in the example shown. The flow groove 104 fluidly connects multiple of the fan ports 80 together to receive the fan air. In the example shown, the inlet ports 110 that feed each of the fan ports 80 open into the flow groove 104 to receive fan air from the flow groove 104. In the example shown, the flow groove 104 extends fully annularly about the body axis BA, though it is understood that not all examples are so limited. The flow groove 104 is open in second axial direction AD2 to receive compressed gas into flow groove 104. The compressed gas within flow groove 104 is output through the fan ports 80.

Flange 84 is disposed on a radially outer side of cap body 76. Flange 84 is configured to interface with collar 18 to allow collar 18 to secure air cap 32 on the spray gun 10. In the example shown, air cap 32 includes a plurality of flanges 84, though it is understood that not all examples are so limited.

Air cap 32 provides significant advantages. Air cap 32 is configured such that fan ports 80 direct flows towards the faces 100a, 100b of the spray pattern. The fan ports 80 are larger than the edge ports 86 such that the fan ports 80 can output greater flow of the compressed gas than the edge ports 86. The greater flow through the fan ports 80 being directed at the width side of the spray pattern facilitates more efficient atomization and shaping by the compressed gas output through air cap 32. The port subsets 82a, 82b being disposed on opposite sides of the spray plane SP directs the fan air towards the width W, providing intuitive control in which increasing flow through the fan ports 80 increases the width W and decreasing flow through the fan ports 80 decreases the width W. Edge ports 86 are oriented towards the pattern edges 98a, 98b and facilitate blending of tails to provide a smooth, even coating finish.

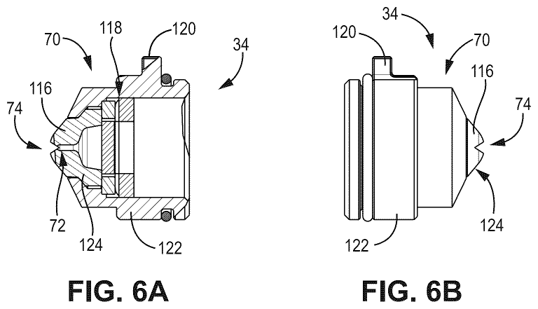

FIG. 6A is a cross-sectional view of spray tip 34. FIG. 6B is a side elevational view of spray tip 34. FIGS. 6A and 6B are discussed together. Spray tip 34 includes tip body 70, orifice 72, tip notch 74, tip dome 116, retainer 118, and projection 120.

Spray tip 34 receives flows of spray fluid and emits the spray fluid as an at least partially atomized spray. In the example shown, tip body 70 is formed by tip housing 122 and tip portion 124. The tip portion 124 is disposed within the tip housing 122. Tip portion 124 is formed from a hardened material, such as from carbide among other options, such as metals and ceramics among others. Retainer 118 is disposed within tip housing 122. Retainer 118 can secure tip portion 124 within tip housing 122.

Spray tip 34 is configured to mount to air cap 32. Spray tip 34 is rotatably fixable to air cap 32 to prevent rotation of the spray tip 34 relative to the air cap 32 on the spray axis SA. In the example shown, projection 120 extends from tip body 70. In the example shown, the projection 120 extends outward from an outer side of tip housing 122. The projection 120 is configured to interface with a portion of air cap 32 to fix the orientation of spray tip 34 relative to air cap 32. In the example shown, the projection 120 is configured to be received by locator 112 to orient spray tip 34 relative to air cap 32.

Tip dome 116 is disposed at a downstream end of tip body 70. Tip dome 116 includes a domed outer surface, which can be partially spherical among other options. Tip notch 74 is formed in tip body 70. In the example shown, the tip notch 74 is formed in tip portion 124. In the example shown, the tip notch 74 is formed in the tip dome 116.

Tip notch 74 is laterally elongate. Tip notch 74 can be formed as a cut in the tip body 70. Tip notch 74 can be formed as a V-shaped cut, among other options. Tip notch 74 can be considered to form a cat-eye configuration. Tip notch 74 intersects with orifice 72 such that coating liquid output through orifice 72 is sprayed through tip notch 74 and then outward from spray tip 34.

During operation, the spray coating liquid flows through spray tip 18 from the upstream end to orifice 72. The spray fluid is emitted through orifice 72 and tip notch 74. The tip notch 74 assists in initial shaping of the spray pattern as the spray plane SP is formed through tip notch 74. The spray plane SP can extend widthwise with tip notch 74. The orientation of tip notch 74 orients the spray pattern output by spray tip 34. The laterally elongate tip notch 74 positions the spray plane SP between the port subset 82a and the port subset 82b, facilitating pattern and atomization by fan air output through fan ports 80.

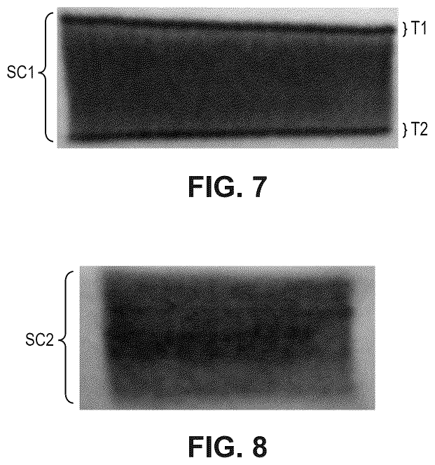

FIG. 7 shows a spray coating SC1 emitted onto a surface by a traditional cap assembly. FIG. 8 shows a spray coating SC2 emitted onto a surface by cap assembly 16. FIGS. 7 and 8 are discussed together. For a traditional cap assembly, the spray plane is oriented through each of the port subsets of the air cap and divides the port subsets. The spray plane extends between the prongs instead of through the prongs. As shown in FIG. 7, the spray coating SC1 includes tails T1, T2 on the edges of the spray coating SC1. The spray coating SC1 was applied with the compressed gas at 90 psi.

As shown in FIG. 8, the spray coating SC2 applied by cap assembly 16 does not include tails. The spray coating SC2 on the surface is a blended, even, and smooth pattern. Further, the spray coating SC2 provides greater coverage and is a larger pattern widthwise than spray coating SC1. The spray coating SC2 was applied with the compressed gas at 30 psi.

Unlike traditional air caps, in which the spray plane is orthogonal to the spray plane SP of cap assembly 16 and extends along the spray axis SA, the configuration of cap assembly 16 facilitates intuitive pattern control and provides smooth blending and efficient pneumatic atomization of the coating liquid. For a traditional cap assembly, increasing the compressed gas pressure decreases the pattern width while decreasing the compressed gas pressure increases the pattern width. Cap assembly 16 provides more intuitive control in that increasing the compressed gas pressure to fan ports 80 increases the pattern width while decreasing the compressed gas pressure to fan ports 80 decreases the pattern width.

Further, orienting fan ports 80 so the outputs are transverse to the spray plane SP and such that the spray plane is between and separates the ports subsets 82a, 82b facilitates efficient atomization of the coating liquid. Orienting the port subsets 82a, 82b towards opposite faces 100a, 100b of the spray output facilitates efficient atomization and provides additional pneumatic atomization to the hydraulic atomization performed by spray tip 34. Cap assembly 16 facilitates efficient blending of the coating liquid to provide for an even, consistent coating. Cap assembly 16 can provide efficient blending at lower pressures, which provides cost and material savings.

The edge ports 86 are oriented towards the edges 98a, 98b of the spray pattern. The output from the edge ports 86 assists in blending at the pattern edges 98a, 98b, preventing the formation of tails and providing a smooth, blended coating on the target surface.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An air cap for a spray gun, the air cap comprising:
a cap body having a central aperture therethrough, the central aperture disposed on a body axis of the cap body;
a plurality of projections extending from an outer side of the cap body; and
a first set of passages extending through the cap body, the first set of passages extending to a plurality of ports open on the outer side, wherein the plurality of ports include:
a first subset of ports disposed circumferentially between a first projection of the plurality of projections and a second projection of the plurality of projections, the first subset of ports oriented to direct a first plurality of airflows towards the body axis and towards a first face of the spray pattern; and
a second subset of ports disposed circumferentially between the first projection and the second projection, the second subset of ports opposing the first subset of ports such that the second subset of parts are oriented to directed a second plurality of airflows towards the body axis and towards a second face of the spray pattern.

2. The air cap of claim 1, further comprising:
a first edge port formed in the first projection and oriented towards the body axis, the first edge port configured to output a first edge flow towards a first edge of the spray pattern.

3. The air cap of claim 2, further comprising a second edge port formed in the second projection and oriented towards the body axis, the second edge port configured to output a second edge flow towards a second edge of the spray pattern.

4. The air cap of any claim 1, wherein the first subset of ports includes:
a first side port configured to output a first side flow;
a second side port configured to output a second side flow; and
a first central port configured to output a first central flow, the first central port disposed between the first side port and the second side port.

5. The air cap of claim 4, wherein the first central port is configured to direct the first central flow towards a first location along the body axis.

6. The air cap of claim 5, wherein the first side port and the second side port are configured to direct the first side flow and the second side flow towards a second location along the body axis.

7. The air cap of claim 6, wherein the second location is spaced axially further from the central aperture than the first location.

8. The air cap of claim 4, wherein the first central port is oriented to output the first central flow axially along the body axis and radially inward towards the body axis, and wherein the first side port is oriented to output the first side flow laterally inward towards the body axis, vertically towards the body axis, and axially along the body axis.

9. The air cap of claim 4, wherein the first side port and the second side port are disposed in opposition such that the first side flow and the second side flow intersect.

10. The air cap of claim 4, wherein the first side port is formed as a mirror image of the second side port.

11. The air cap of claim 4, wherein the first central port is radially offset from the first side port and the second side port.

12. The air cap of claim 11, wherein the first central port extends radially closer to the body axis than the first side port and the second side port.

13. The air cap of claim 4, wherein:
the second subset of ports includes:
a third side port configured to output a third side flow;
a fourth side port configured to output a fourth side flow; and
a second central port configured to output a second central flow, the second central port disposed between the third side port and the fourth side port; and
the first central port is disposed in opposition to the second central port such that the first central flow is directed towards the second central flow and the second central flow is directed towards the first central flow.

14. The air cap of claim 13, wherein the first side port is oriented to direct the first side flow towards a second location along the body axis, the second side port is oriented to direct the second side flow towards the second location, the third side port is oriented to direct the third side flow towards the second location, and the fourth side port is oriented to direct the fourth side flow towards the second location.

15. The air cap of claim 14, wherein the first central port is oriented to direct the first central flow towards a first location along the body axis, and the second central port is oriented to direct the second central flow towards the first location, and the first location is disposed axially closer to the central aperture than the second location.

16. The air cap of claim 1, further comprising a flow groove extending into an inner side of the cap body, the flow groove fluidly connected to multiple passages of the plurality of passages.

17. The air cap of claim 1, wherein:
the outer side includes a first sloped portion having a first face oriented towards the body axis and a second sloped portion having a second face oriented towards the body axis;
the first subset of ports are at least partially formed through the first face; and
the second subset of ports are at least partially formed through the second face.

18. The air cap of claim 1, wherein:
each port of the first subset of ports extends between a first port inlet and a first port outlet, the first port outlet formed through the outer side;
each port of the second subset of ports extends between a second port inlet and a second port outlet, the second port outlet formed through the outer side.

19. A spray cap assembly for use with a spray gun, the spray cap assembly comprising:
a spray tip including:
a tip body having a spray orifice formed therethrough; and
a tip notch formed in the tip body, the tip notch extending laterally such that a spray pattern emitted from the spray tip is laterally elongate, wherein the spray orifice opens into the tip notch; and
an air cap comprising:
a cap body supporting the spray tip, the cap body having a central aperture therethrough, the central aperture disposed on a body axis of the cap body;
a plurality of projections extending from an outer side of the cap body; and
a first set of passages extending through the cap body, the first set of passages extending to a plurality of ports open on the outer side, wherein the plurality of ports include:
a first subset of ports disposed circumferentially between a first projection of the plurality of projections and a second projection of the plurality of projections; and
a second subset of ports disposed circumferentially between the first projection and the second projection;
wherein the first subset of ports oriented to direct a first plurality of airflows towards the body axis and towards a first broad face of the spray pattern; and
wherein the second subset of ports opposing the first subset of ports such that the second subset of parts are oriented to directed a second plurality of airflows towards the body axis and towards a second broad face of the spray pattern.

20. A method of spraying a coating liquid, the method comprising:
outputting the coating liquid through a spray tip, the spray tip atomizing the coating liquid into a liquid spray shaped to have a width between a first pattern side and a second pattern side and a thickness between a first pattern face and a second pattern face, the width greater than the thickness;
outputting compressed gas through an air cap and towards the spray pattern such that:
a first portion of the compressed gas is output through a first plurality of ports and towards the first pattern face; and
a second portion of the compressed gas is output through a second plurality of ports and towards the second pattern face; and
adjusting flow of the first portion of the compressed gas and the second portion of the compressed gas to change the width of the spray pattern, wherein increasing the flow of the first portion of the compressed gas and the second portion of the compressed gas increases the width and decreasing the flow of the first portion of the compressed gas and the second portion of the compressed gas decreases the width.
